(19) United States
(12) Patent Application Publication
(10) Pub. No.: US 2018/0318777 A1
(43) Pub. Date: Nov. 8, 2018

(54) AN APPARATUS AND A METHOD FOR GENERATING AND INFUSING A GAS INTO A LIQUID DRINK

(71) Applicant: Frank HARTMANN, County Longford (IE)

(72) Inventor: Frank HARTMANN, County Longford (IE)

(21) Appl. No.: 15/775,644

(22) PCT Filed: Nov. 10, 2016
(86) PCT No.: PCT/EP2016/077349

§ 371 Date: May 11, 2018

(30) Foreign Application Priority Data
Nov. 13, 2015 (GB) 1520053.8

(51) Int. Cl. B01F 3/04; A23L 2/54; B01D 53/22

(52) U.S. Cl. CPC B01F 3/04808; B01F 3/04269; B01F 3/04815; A23L 2/54; B01D 2053/224; B01F 2003/04404; B01F 2003/04921; A23V 2002/00; B01D 53/229

(57) ABSTRACT

The present invention is directed towards a liquid drink dispensing apparatus. The apparatus comprises a gas generating component and a liquid drink dispensing component. The generated gas is supplied to the liquid drink dispensing component which infuses the generated gas into a liquid drink prior to dispensing the gas-infused liquid drink. The advantage of using a gas generating component is that the gas can be created on-site and no bottled gas needs to be used. This obviates the problems associated with purchasing, storing, using and replacing gas cylinders.

This invention relates to an apparatus for generating and infusing a gas into a liquid.

In particular, the present invention is directed towards an apparatus for generating and infusing nitrogen into a potable liquid drink. It will be readily understood that whilst the present invention is directed towards the generation and infusion of nitrogen into a liquid drink, other types of gases may be generated and infused into other types of liquids, which may or may not be potable, and such embodiments are considered to fall within the scope of the present invention.

In many drinks establishments, it has become commonplace to infuse cold liquid drinks, such as coffee and tea, with a gas, such as nitrogen, prior to serving the liquid drinks from a dispensing machine. The purpose of infusing cold brew coffee/tea with the gas prior to serving is to create a frothier and creamier drink. This improves the taste and appearance of the drink being served.

In general, when reviewing prior art gas-infused liquid drinks dispensing apparatuses, it can be seen that it is typical for bottled gas, held under pressure, to be connected to a dispensing tap in order to infuse gas bubbles into the liquid drink prior to dispensing the gas-infused liquid drink out of the dispensing tap. This is the most common way for gas to be infused into a liquid drink in accordance with the prior art. This arrangement requires the use of bottled gas cylinders which can be costly and somewhat cumbersome to use. The bottles are heavy to lift and replace and staff may be unable to do so.

Furthermore, any establishments using these types of dispensing taps which utilise bottles gas must order and maintain a supply of the bottled gas cylinders. This supply and maintenance requirement adds a further managerial task for an establishment owner and the storage of the bottled gas cylinders requires space to be reserved for the spare bottles of gas. Moreover, the cylinders need to be swapped out from time to time which requires training for users, and, there is always a danger present when handling and moving bottled gas, where the gas is held under pressure as would be the case here.

In many jurisdictions, there currently exists regulations regarding the handling and storage of gas cylinders for safety and health reasons, and compliance with these regulations is burdensome and again is an additional task which must be borne by the establishment owner.

Also, if the supply of bottled gas runs out during operation, this could damage the dispensing tap apparatus, as the lack of pressurised gas may allow reverse flow of liquid in directions which are undesirable for the future smooth operation of the dispensing tap. For example, the absence of a gas may cause a gas infusing module of the dispensing tap to flood as there will be no gas to push back against the pressure of the liquid drink. It is well known in the dispensing industry that a flooded component can take a dispensing tap out of service for up to twenty-four hours, which results in a substantial loss of sales and also results in customer dissatisfaction. Additionally, a flooded component is not optimal for the component's operational lifespan and performance. Components, such as gas infusing modules, are relatively expensive pieces of equipment that need to be protected from flooding. Over a period of time, if the liquid pressure is applied to the gas infusing module prior to the gas pressure, this will result in having the gas infusing module's performance degrade over an extended period of time until complete saturation point is reached and the component will need to be replaced.

Nonetheless, in spite of the problem mentioned above, many prior art gas-infusing drinks dispensing systems use bottled gas. As discussed above, Nitrogen (N₂) is an example of the type of gas which is used for infusion into liquid drinks.

Nitrogen has become popular for infusing teas and in particular coffee, as the nitrogen bubbles are relatively small (when compared with carbon dioxide) and as a result a frothier and fresher-looking coffee/tea can be dispensed. It shall be noted that for the ease of discussion, the present invention will focus on the use of nitrogen to be infused into coffee. However, it will be readily appreciated that nitrogen can be infused into other types of potable liquid drinks, and other types of gases can be infused into other types of liquid, in accordance with the present invention.

Typically the coffee will be kept in a container, such as a bag-in-box type container, ready to be dispensed from the dispensing tap, and as the tap is released to pour the coffee, the nitrogen in the bottle gas cylinder will be infused in-line into the coffee as it is being poured out of the tap. Other types of containers are envisaged such as syrup cartridges and the like which are well known in the art. At present, bottled nitrogen is used in coffee dispensing machines to produce a frothier coffee. However, this approach and type of apparatus suffers from the problems discussed hereinbefore and further below with respect to the specific example of prior art mentioned.

An example of prior art is European Patent Publication Number EP 0 947 463. EP 0 947 463 discloses an apparatus for dispensing a liquid drink and in particular beer. A mixture of carbon dioxide and nitrogen is infused into the beer prior to the dispensing. EP 0 947 463 discloses that a gas, such as nitrogen, is controllably dissolved in a line of beer as it flows from the keg towards a dispensing tap. A hollow fibre membrane is used to control the gas dissolution into the beer. EP 0 947 463 does not disclose generating the nitrogen (or carbon dioxide). EP 0 947 463 discloses sourcing the gas from a gas source such as bottled gas. It will further be appreciated that serving beer with gas infused within and a beverage such a coffee with a gas infused within present different problems and issues for the user and the technology for a beer-based dispensing system is not readily applicable to a coffee-dispensing system without substantial modification. EP 0 947 463 suffers from all of the problems mentioned hereinabove in respect of using bottled gas as a gas source.

Nitrogen is also known within liquid drinks dispensing systems to be used as an inert gas which can maintain a higher quality of liquid drink when the liquid drink is being stored, after preparation, for immediate pouring on demand. As such, nitrogen can be used to take up free space in a coffee storage pot and prevent air, which would otherwise have occupied that free space, from oxidising the prepared coffee that is being stored and held in the coffee pot. Japanese Patent Publication JP 2008194074 discloses a coffee machine. Coffee is brewed by dripping hot water through a coffee powder and the coffee is then stored in a pot in the coffee machine. As storage of coffee for a period of time can cause the brewed coffee to oxidise, JP 2008194074 proposes to generate an inert gas, such as nitrogen, and pump this gas into the pot of coffee so that the deterioration of the coffee in the pot over time is mitigated. In order to generate the nitrogen gas, JP 2008194074 discloses using a permeable membrane. The permeable membrane is a hollow fibre membrane. Compressed air is passed into the hollow fibre membrane to allow non-nitrogen gas to permeate out and nitrogen gas is output from the hollow fibre membrane. This generate nitrogen is supplied to the pot storing the coffee, under pressure, so as to minimise the oxidation of the coffee stored in the pot. There is no hint or incitement within JP 2008194074 to use the generated nitrogen within the liquid drink to be dispensed itself. In fact, JP 2008194074 is silent on infusing the coffee with any type of gas.

Similarly, U.S. Patent Publication US 2009/0165655 discloses a coffee machine which is broadly similar to that described in JP 2008194074. The main problem addressed by the disclosure of US 2009/0165655 is the heating of the coffee pot whilst cutting off thermal conduction between the pot and the environment. US 2009/0165655 also discusses the prevention of oxidation of the coffee after it is brewed and is being stored in a pot, through the use of nitrogen. US 2009/0165655 discloses a drip brewed coffee. Nitrogen is generated and is pumped into the pot to again take the place of air which would otherwise have caused oxidation of the brewed coffee in the pot. Again, US 2009/0165655 is silent on infusing the coffee with the generated nitrogen. Moreover, there is no disclosure within US 2009/0165655 of how the nitrogen used in US 2009/0165655 is generated.

It is a goal of the present invention to provide a liquid drink dispensing apparatus that overcomes at least one of the above mentioned problems. Furthermore, it is more generally a goal of the present invention to provide a gas infuser apparatus which infuses a gas into a liquid and overcomes at least one of the above mentioned problems. Furthermore, it is also a goal of the present invention to provide a gas generation and gas infuser apparatus which generates a gas and then infuses the generated gas into a liquid, whilst overcoming at least one of the above mentioned problems.

### SUMMARY OF THE INVENTION

The present invention is directed to a liquid drink dispensing apparatus comprising a gas generating component and a liquid drink dispensing component; whereby, the gas generating component generates a gas and supplies the generated gas to the liquid drink dispensing component which infuses the generated gas into a liquid drink prior to dispensing the gas-infused liquid drink.

The advantage of using a gas generating component is that the gas can be created on-site and no bottled gas needs to be used. This obviates the problems associated with purchasing, storing, using and replacing gas cylinders. It is not obvious to use gas generated by a gas generating component, such as used in the prior art, to feed the gas to the liquid drink dispensing component for infusing the generated gas into the liquid drink. The gas infusing module of the prior art and the gas generating module of the prior art have not been combined together despite both technologies co-existing for many years, and, both technologies being known and used within the drinks dispensing industry. Moreover, the technologies can simply be combined without their being a substantial design process to ensure the smooth operation of the different modules together. Thus, although it would not be obvious to combine the existing technologies known from the prior art, even if one were to attempt to do so, technological issues regarding compatibility due to flowrates, purity levels and so on would be encountered and these issues would require the use of design activity to become rectified.

In a further embodiment, the gas generating component comprises a gas generating module to generate the gas; and, the liquid drink dispensing component comprises a gas infusing module to infuse the generated gas into the liquid drink.

In a further embodiment, the gas generating module generates the gas intermittently, but sufficiently so as to create a continuous supply of gas from a buffer tank.

One of the above mentioned problems with the prior art solutions, which all rely on the use of bottled gas for infusing gas into a liquid drink, is that the liquid drink dispensing apparatus can become damaged due to reverse flow if the gas supply is exhausted. In such a scenario, the gas infusing module could flood due to the lack of any gas. The solution of the present invention to this problem is to generate the gas using a gas generating module so as to create a continuous supply of gas.

In a further embodiment, the gas generating module comprises a gas generating hollow fibre membrane module which generates the gas by separating the gas from a gaseous mixture; and, the gas infusing module comprises a gas infusing hollow fibre membrane module to infuse the generated gas into the liquid drink.

The advantage of providing the hollow fibre membrane is a particularly effective way to generate a gas for infusing into a liquid drink, which heretofore has been ignored and dismissed as being an industrial process unsuited to such small scale gas production for infusing a liquid drink.

In a further embodiment, the gas generating component comprises a compressor which supplies a compressed gaseous mixture to the gas generating module, and, a buffer tank which stores the generated gas from the gas generating module and supplies the generated gas to the liquid drink dispensing component; whereby, the gas generating component further comprises a pressure switch connected to the buffer tank such that the pressure switch controls the operation of the compressor based on the pressure level in the buffer tank.

The advantage of providing the pressure switch connected to the buffer tank is that the operation of the compressor can be minimised and the running costs and wear and tear of the compressor can be reduced as a consequence.

In a further embodiment, the pressure switch sends a signal to a controller which then processes the signal from the pressure switch and, in turn, may transmit an activation signal to the compressor so as to activate the operation of the compressor.

The advantage of activating the operation of the compressor based on the pressure in the buffer tank is that any potential problem with maintaining correct pressure in the apparatus is obviated. If only liquid pressure were to be applied to gas infusing module, without equal or greater gas pressure on the other side of the gas infusing module, the gas infusing module could become liquid logged. The solution to this is by way of the use of the pressure switch to ensure that the pressure in the buffer tank, which feeds a gas side of the gas infusing module, will be greater than the liquid side of the gas infusing module and thus obviate any possibility that the gas infusing module would become liquid logged.

It shall be noted that the side wall of the gas generating module and/or the side wall of the gas infusing module are interchangeably referred to as a skin throughout this specification. And, the gas side of the side wall, or skin, of the gas infusing module shall be understood the refer to the side of the side wall of the gas infusing module which has a gas feed to it, and the liquid side of the side wall, or skin, of the gas infusing module shall be understood to be the side of the gas infusing module which has the liquid feed to it. The gas side of the gas infusing module will thus be the interior side wall of the hollow fibre tube(s) of the hollow fibre membrane, and, the liquid side of the gas infusing module will be the exterior side wall of the hollow fibre tube(s).

In a further embodiment, the operation of the compressor is activated when the pressure level in the buffer tank falls below a preset minimum pressure level.

The advantage of using a preset minimum pressure level is that the system can ensure this preset minimum pressure level will be greater than the pressure present by the liquid drink on the gas infusing module. In this way, the present invention presents an automated method and apparatus to prevent membrane flooding when using a gas infusing module, such as a hollow fibre membrane, to infuse the gas into the liquid drink. This method and apparatus will supports the hollow fibre membrane performance over the lifetime of the membrane, and lengthen the operational lifetime of the gas infusing hollow fibre membrane module.

In a further embodiment, the pressure level in the buffer tank will be advantageously held at a pressure in the range of 55 p.s.i. and 65 p.s.i. This pressure range has been found to be particularly effective.

In a further embodiment, the gaseous mixture fed into the gas generating module is air and the gas generated by the gas generating module is nitrogen.

In a further embodiment, the gas infusing module comprises a plurality of hollow fibre tubes housed within a mixing chamber, and, the liquid drink is fed into the mixing chamber on one side of a skin of the hollow fibre tubes and the gas is fed through the other side of the skin of the hollow fibre tubes, whereby the gas passes through the skin of one or more of the plurality of hollow fibre tubes to infuse into the liquid drink in the mixing chamber, prior to the liquid drink being dispensed from the mixing chamber. In a further embodiment, the mixing chamber comprises an outlet which is connected to a dispensing tap.

It shall be noted that the side wall of the gas generating module and/or the side wall of the gas infusing module are interchangeably referred to as a skin throughout this specification.

In a further embodiment, the liquid drink will not be fed into the mixing chamber until the pressure in the buffer tank has risen above the preset minimum pressure level.

This is advantageous as it ensures that the pressure of the gas on one side of the skin of the gas infusing chamber will be greater than the pressure of the liquid drink on the other side of the skin of the gas infusing module, and thus ensure that the liquid drink cannot pass through the skin of the gas infusing module, but only the gas will pass through the skin of the gas infusing module. Therefore, the liquid drink cannot liquid log the gas infusing module when the liquid drink dispensing apparatus is arranged to ensure that the pressure on the gas side of the gas infusing module is always greater than the pressure on the liquid drink side of the gas infusing module.

In a further embodiment, the liquid drink dispensing apparatus comprises a dispensing tap. In yet a further embodiment, the opening of the dispensing tap will initiate the infusion of the gas into the liquid drink by activating one or more of the compressor, the gas generating module, the gas infusing module, and/or the feeding of the liquid drink into the mixing chamber.

In a further embodiment, the liquid drink is coffee. In a further embodiment, the liquid drink is tea.

The present invention is further directed towards a gas infuser apparatus, whereby, the gas infuser apparatus comprises a gas generating component and a gas infusing component; whereby, the gas generating component generates a gas and supplies the generated gas to the gas infusing component which infuses the gas into a liquid.

It will be understood that the same design features of the liquid drink dispensing apparatus can be utilised, mutatis mutandis, for the gas infuser apparatus as these embodiments both reside in the crux of the present invention.

In a further embodiment, the gas generating component comprises a gas generating module to generate the gas; and, the gas infusing component comprises a gas infusing module to infuse the generated gas into the liquid.

In a further embodiment, the gas generating module comprises a gas generating hollow fibre membrane module which generates the gas by separating the gas from a gaseous mixture; and, the gas infusing module comprises a gas infusing hollow fibre membrane module to infuse the generated gas into the liquid.

In a further embodiment, the gas generating component comprises a compressor which supplies a compressed gaseous mixture to the gas generating module, and, a buffer tank which stores the generated gas from the gas generating module and supplies the generated gas to the gas infusing component; whereby, the gas generating component further comprises a pressure switch connected to the buffer tank such that the pressure switch controls the operation of the compressor based on the pressure level in the buffer tank.

In a further embodiment, the pressure switch sends a signal to a controller which then processes the signal from the pressure switch and, in turn, may transmit an activation signal to the compressor so as to activate the operation of the compressor.

In a further embodiment, the operation of the compressor is activated when the pressure level in the buffer tank falls below a preset minimum pressure level.

In a further embodiment, the pressure level in the buffer tank will be advantageously held at a pressure in the range of 55 p.s.i. and 65 p.s.i.

In a further embodiment, the gas infusing module comprises a plurality of hollow fibre tubes housed within a mixing chamber, and, the liquid is fed into the mixing chamber on one side of a skin of the hollow fibre tubes and the gas is fed through the other side of the skin of the hollow fibre tubes, whereby the gas passes through the skin of one or more of the hollow fibre tubes to infuse into the liquid in the mixing chamber, prior to the liquid being dispensed from the mixing chamber. In a further embodiment, the mixing chamber comprises an outlet which is connected to a dispensing tap.

In a further embodiment, the liquid will not be fed into the mixing chamber until the pressure in the buffer tank has risen above the preset minimum pressure level.

In a further embodiment, the gaseous mixture fed into the gas generating module is air and the gas generated by the gas generating module is nitrogen. In a further embodiment, the liquid drink is coffee. In a further embodiment, the liquid drink is tea.

In a further embodiment, the gas infusing apparatus comprises a dispensing tap. In yet a further embodiment, the opening of the dispensing tap will initiate the infusion of the gas into the liquid by activating one or more of the compressor, the gas generating module, the gas infusing module, and/or the feeding of the liquid into the mixing chamber.

The present invention is further directed towards a process for infusing a liquid drink with a gas, the process comprising: delivering a pressurised gaseous mixture into a gas generating module which is used to separate the gaseous mixture into the gas and an unwanted gas; and, delivering the selected gas to a gas infusing module which is used to infuse the generated gas into the liquid drink. It will be understood that the gas may be a gas or gaseous mixture and/or the unwanted gas could be a gas or a gaseous mixture.

It will be understood that the same design features of the liquid drink dispensing apparatus and the gas infuser apparatus are present in respect of the described process for infusing a liquid drink with a gas and thus the above mentioned feature and advantages can be applied, mutatis mutandis, to the description and envisaged embodiments of the process as these features reside in the crux of the present invention.

In a further embodiment, the gas generating module comprises a gas generating hollow fibre membrane module; and, the gas infusing module comprises a gas infusing hollow fibre membrane module.

In a further embodiment, the process further comprises extracting one of the gas or the unwanted gas through a side wall of the gas generating hollow fibre membrane module, and, discharging the other of the selected gas and the unwanted gas through an outlet of the gas generating hollow fibre membrane module.

In a further embodiment, the process further comprises passing the gas through a gas infusing hollow fibre membrane module, whereby the gas infusing hollow fibre membrane module comprises a plurality of hollow fibre tubes housed within a mixing chamber such that the gas emanates from one or more of the plurality of hollow fibre tubes in the gas infusing hollow fibre membrane module and is infused into a liquid drink which is fed in the mixing chamber of the gas infusing hollow fibre membrane module.

In a further embodiment, the process includes purifying the selected gas downstream of the gas generating module before delivering the selected gas to the gas infusing module.

In a further embodiment, the process includes delivering the gas discharged from the gas generating module to a buffer tank and storing a quantity of the selected gas at a preset pressure in the buffer tank upstream of the gas infusing module.

In a further embodiment, the process includes pressurising the gaseous mixture upstream of the gas generating module by delivering the gaseous mixture through a compressor, a pressurised gas outlet of the compressor communicating with an inlet of the gas generating module.

In a further embodiment, the process comprises sensing the gas pressure within the buffer tank and controlling operation of the compressor in response to said sensed gas pressure for maintaining the selected gas at a desired pressure in the buffer tank.

In a further embodiment, the process includes filtering the pressurised gaseous mixture in a filter mounted between the compressor and the gas generating module.

In a further embodiment, the process includes regulating the pressure of the gaseous mixture delivered to the gas generating module by means of a pressure regulator mounted upstream of the gas generating module.

In a further embodiment, the process comprises purifying the selected gas upstream of the gas infusing module.

In a further embodiment, the process comprises feeding the liquid drink from a liquid drink reservoir into the mixing chamber.

In a further embodiment, the liquid drink may not be dispensed until the pressure in the buffer tank has risen above the preset minimum pressure level.

In a further embodiment, the liquid drink will not be fed into the mixing chamber until the pressure in the buffer tank has risen above the preset minimum pressure level.

In a further embodiment, the liquid drink is dispensed through a dispensing tap. In yet a further embodiment, the opening of the dispensing tap will initiate the infusion of the gas into the liquid drink by activating one or more of the compressor, the gas generating module, the gas infusing module, and/or the feeding of the liquid drink into the mixing chamber.

In a further embodiment, the gaseous mixture is air and the selected gas is nitrogen. In a further embodiment, the liquid drink is coffee. In yet a further embodiment, the liquid drink is tea.

### DETAILED DESCRIPTION OF EMBODIMENTS

The invention will be more clearly understood from the following description of some embodiments thereof, given by way of example only, with reference to the accompanying drawings, in which:

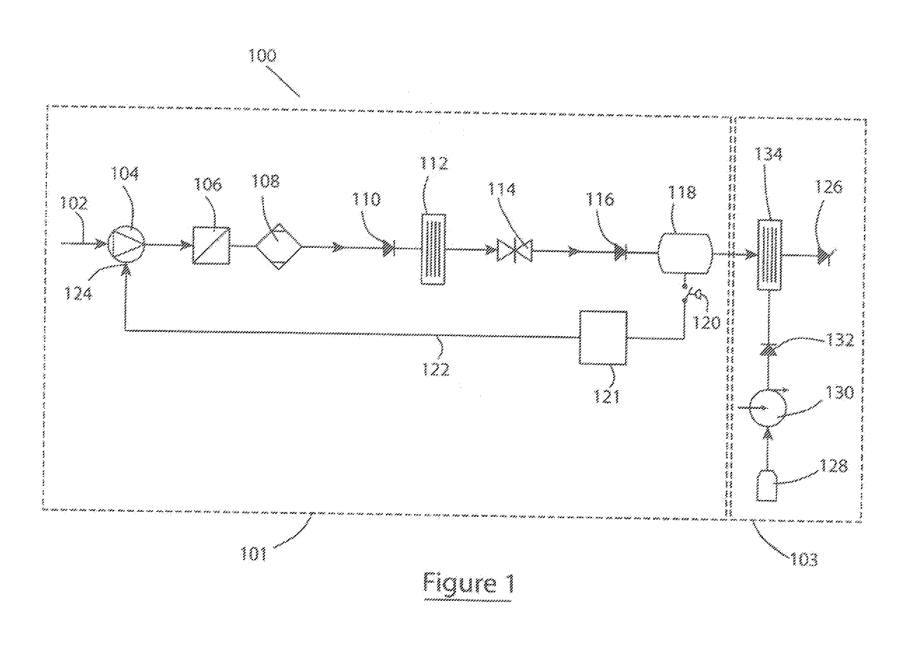

FIG. 1 is a circuit diagram of a liquid drink dispensing apparatus for infusing a gas into a liquid drink in accordance with the present invention;

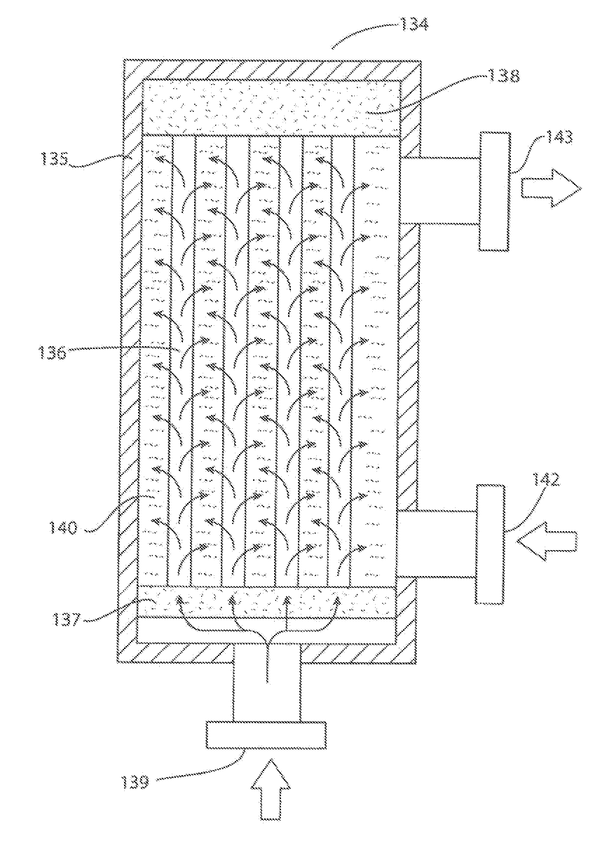

FIG. 2 is a schematic sectional elevational view of a gas infusing hollow fibre membrane module forming portion of the liquid drink dispensing apparatus of FIG. 1; and,

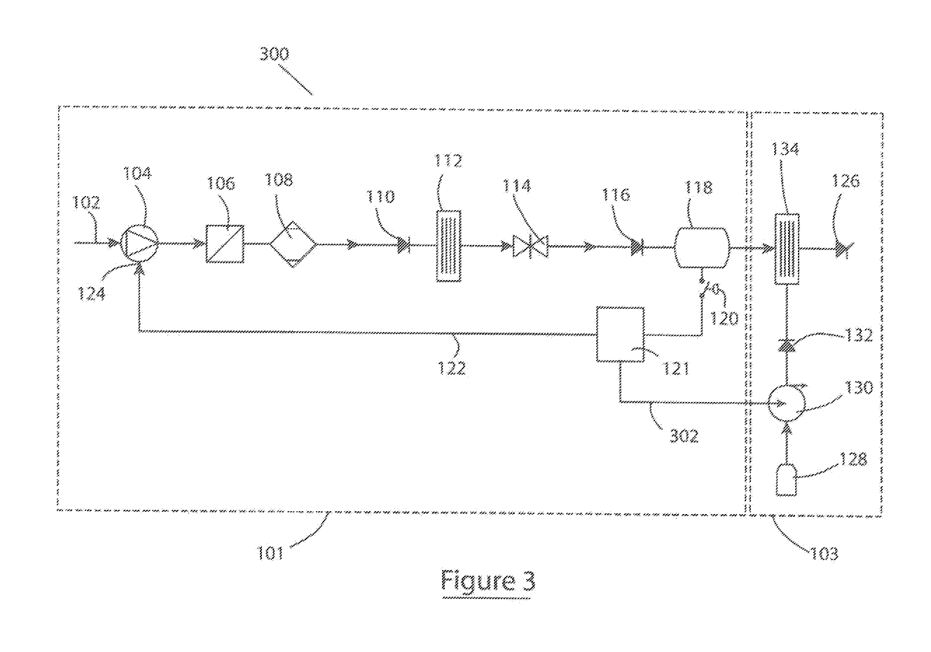

FIG. 3 is a circuit diagram of a liquid drink dispensing apparatus for infusing a gas into a liquid drink in accordance with a further embodiment of the present invention.

Referring to the drawings, there is provided a liquid drink dispensing apparatus indicated generally by reference numeral 100. The liquid drink dispensing apparatus 100 comprises a gas generation component 101 and a liquid dispensing component 103, whereby the gas generated by the gas generation component 101 is delivered to the liquid dispensing component 103 so that the generated gas can be infused into a liquid drink in the liquid dispensing component 103, prior to the gas-infused liquid drink being dispensed.

Gas is generated using a gas generating module, such as, in a preferred embodiment, a gas generating hollow fibre membrane module. These membrane modules are well-known in the art as being used in larger industrial applications. In the case of nitrogen generation, air is compressed and forced through hollow fibres which are semi-permeable. The permeability of the hollow fibres can be set so as to cause a separation of molecules when air is passed through the hollow fibre. Air is passed into one end of the hollow fibre and the oxygen (O₂) molecules, the water vapour (H₂O) and the carbon dioxide (CO₂) molecules in the air as well as other impurities permeate out through the hollow fibre membrane however the nitrogen (N₂) does not (or at least is much slower to permeate through) due to its molecular size and by feeding the air into one end of the hollow fibre at a certain pressure, causing a certain flowrate, the nitrogen will for the most part remain within the hollow fibre and will be expelled as substantially pure nitrogen out of an opposing end of the hollow fibre. As stated above, this is known in the art for use in other fields where large scale nitrogen production is required, but has never been considered for small levels of nitrogen production as is the case with the present invention. It will be readily appreciated that alternative types of gas generating modules may be used in place of a gas generating hollow fibre membrane module.

Referring to FIG. 1, and specifically to the gas generation component 101 of the liquid drink dispensing apparatus 100, there is provided an air intake 102 which supplies air, taken from the atmosphere, into a compressor 104. The compressor 104 draws the air through the air intake 102 and into the compressor 104. Compressed air discharged from the compressor 104 is fed through a filter 106 and a regulator 108 to remove impurities and moisture from the compressed air and to control the pressure of the compressed air as it is fed further along through the gas generation component 101. The filter 106 may preferably be a carbon filter. A non-return valve 110 is provided in advance of the gas generating hollow fibre membrane module 112 which separates nitrogen (N₂) from the air as discussed hereinabove. A nitrogen purity level of approximately 97%-98% can be expected. The other elements of the air are released into the atmosphere from the gas generating hollow fibre membrane module 112. It will be appreciated that cooling coils may be used to cool air expelled from the compressor 104 and/or water separators may also be used to remove water from the compressed air. Such elements and components are well known in the art and will not be described in any further detail in this specification.

The nitrogen (N₂) is fed onwards to a needle purity valve 114 which can be set to a specific purity setting. A purity in the range of 95%-99% is considered to be sufficient for infusing a liquid drink, and preferably a purity level of 97% is used as this is considered to be pure enough for use whilst higher purity levels do not offer an advantageous cost-benefit.

A further non-return valve 116 is provided in advance of a buffer tank 118. The nitrogen (N₂) that has been generated is held in the buffer tank 118 and is held at a pressure equal to or greater than a preset minimum pressure level. In a preferred embodiment, the minimum pressure level shall be substantially 55 p.s.i. (pounds per square inch). In a further embodiment, the maximum pressure level in the buffer tank 118 is envisaged to be approximately 65 p.s.i. If nitrogen is released from the buffer tank 118 and the pressure level drops below the preset minimum pressure level, a pressure activated switch 120 will send a control signal to a controller 121. The controller 121 will process the signal from the pressure switch 120 and will then transmit an activation signal along a compressor control signal line 122 to activate the operation of the compressor 104. The controller 121 can process the signals from the pressure switch 120 and ensure a smoother start-up and shut-down of the compressor 104. The controller 121 can regulate the r.p.m. of the compressor 104 and control the amount of air that is forced towards the gas generating hollow fibre membrane module 112. In this manner, the compressor 104, which can be relatively expensive to operate, will only operate when it is deemed necessary to do so in order to maintain the desired level of pressure in the buffer tank 118 and the controller 121 will manage the smooth activation of the operation of the compressor 104 so that it is not started and stopped abruptly numerous times in close succession.

As can be seen the operation of the gas generation component 101 ensures that a preset minimum pressure level of nitrogen is held in the buffer tank 118 and is available for use in the liquid drink dispensing apparatus 100, whilst minimising the operating time of the compressor 104 which is advantageous from a running costs perspective and from an operational lifespan. This will also avoid the problems of liquid logging a hollow fibre membrane in the liquid dispensing component 103, as have been discussed in more detail hereinabove.

Turning now to the liquid dispensing component 103 of the liquid drink dispensing apparatus 100, a liquid drink, such as coffee, is dispensed from a dispensing tap 126. The liquid drink to be dispensed is stored in a container 128 which forms a liquid drink reservoir. The container 128 may be the typical bag-in-box type container as is used in the drinks industry, or could alternatively be a keg or other such drinks container. A pump 130 is used to force the liquid drink through the liquid dispensing component 103. The pump 130 may be preferably activated by the opening of the dispensing tap 126. A non-return valve 132 is provided downstream of the pump 130 and a gas infusing module 134 is provided after the non-return valve 132. In further preferred embodiments, the opening of the dispensing tap 130 may also be used to operate one or more of the compressor 104, the gas generating module 112, the gas infusing module 134, and/or the pump 130 to feed the liquid drink from the container 128 to the gas infusing module 134. In FIG. 3, the controller 121 sends an activation signal 302 to the pump 130. In this embodiment, the activation of the pump 130 can be controlled by the controller 121 so as to ensure operation of the compressor 104 for a preselected period of time prior to any activation of the pump 130.

In a preferred embodiment, the gas infusing module 134 is a gas infusing hollow fibre membrane module, as described in more detail with reference to FIG. 2.

The gas infusing hollow fibre membrane module 134 is shown in more detail in FIG. 2. The gas infusing hollow fibre membrane module 134 has a cylindrical casing 135 which forms a mixing chamber 140. Housed within the casing 135, of the gas infusing hollow fibre membrane module 134 are a plurality of hollow fibre tubes 136 extending between resin supports 137, 138 at opposite ends of the mixing chamber 135. Open inlet ends of the hollow fibre tubes 136, embedded in the support 137, receive nitrogen from a nitrogen inlet 139 of the mixing chamber 140 which is connected to the buffer tank 118. Opposite ends of the hollow fibre tubes 136, embedded in the support 138, are closed. Thus, nitrogen entering the mixing chamber 140 enters inside the hollow fibre tubes 136 (on the gas side of the hollow fibre tubes) and permeates outwardly through side walls of one or more of the plurality of hollow fibre tubes 136 into the mixing chamber 140 of the casing 135. A liquid inlet 142 and an aerated liquid outlet 143 are provided in a side wall of the casing 135 for circulation of liquid, in this case coffee, through the mixing chamber 140. As the coffee travels through the mixing chamber 140 between the liquid inlet 142 and the aerated liquid outlet 143, it surrounds the plurality of hollow fibre tubes 136 and is infused with nitrogen which permeates through one or more of the hollow fibre tubes 136 into the mixing chamber 140 of the gas infusing module 134.

The gas infusing hollow fibre membrane module 134 operates in a different manner to gas generating hollow fibre membrane module 112 discussed previously. The gas infusing hollow fibre membrane module 134 receives the pumped liquid from the container 128 and also intakes nitrogen (N₂) from the buffer tank 118. Due to the fact that the buffer tank 118 holds nitrogen (N₂) at pressure, the nitrogen will be forced into the gas infusing hollow fibre membrane module 134. The nitrogen (N₂) from the buffer tank 118 is passed through the plurality of hollow fibre tubes 136, which on this occasion have a different permeability so as to allow the nitrogen (N₂) to escape through the hollow fibre tubes 136 and into the mixing chamber 140 formed by the casing 135. The hollow fibre tubes 136 are closed ended so that all of the nitrogen (N₂) from the buffer tank 118 which is passed into the hollow fibre tubes 136 will permeate through the hollow fibre tubes 136 and infuse the liquid drink held in the mixing chamber 140. The pressure of the nitrogen on the gas side of the skin of the plurality of hollow fibre tubes 136 is greater than the pressure of the liquid which surrounds the plurality of hollow fibre tubes 136 in the mixing chamber 135. This ensures that the gas infusing hollow fibre membrane module 134 will not become liquid logged. As discussed hereinbefore, the pressure switch 120, controller 121, compressor 104 and buffer tank 118 ensure that the pressure of the nitrogen delivered to the plurality of hollow fibre tubes 136 is above a minimum pressure level so that the nitrogen is at a pressure higher than the pressure of the liquid in the mixing chamber 140. As discussed with reference to FIG. 3, sequential operation of the compressor 104 and the pump 130 can also be used to ensure this, by running the compressor for a period of time before operating the pump 130. In this way, time is given for the compressor 104 to generate nitrogen which will be fed into the buffer tank 118 and increase the pressure level in the buffer tank 118 to an acceptable level before pumping the liquid from the container 128 into the mixing chamber 140 and increasing the pressure of the liquid in the mixing chamber 140.

Referring to FIGS. 1 and 2, the liquid drink is fed into the mixing chamber 140, forming part of the gas infusing hollow fibre membrane module 134, which casing 135 substantially surrounds and houses the plurality of hollow fibre tubes 136. As the nitrogen (N₂) permeates out of one or more of the hollow fibre tubes 136, it becomes infused into the liquid drink which is surrounding the hollow fibre tubes 136 and has been fed by a pump 130 from a container 128 into the mixing chamber 140 of the gas infusing hollow fibre membrane module 134. It will be understood that when the liquid drink is not being dispensed, the liquid drink will be stagnant in the membrane module 134 and the liquid adjacent the hollow fibre tubes will become saturated with nitrogen as the liquid drink is stagnant. This saturation of the liquid drink which is stagnant and adjacent the hollow fibre tubes will cause the nitrogen (N₂) to be ceased to be drawn out of and permeating through the hollow fibre tubes. When the dispensing tap 126 is opened and the liquid drink starts to flow again, the liquid drink which is saturated with nitrogen (N₂) will flow away and out of the tap 126 and the liquid drink which replaces it will not have any, or very little, nitrogen (N₂) and therefore the nitrogen (N₂) will be drawn out and permeate through the hollow fibre tubes in the membrane module 134 again and continue to infuse the liquid drink.

This infusion process is seen to be advantageous as it is considered to be better than bubble diffusers given that the nitrogen is infused into the liquid drink at relatively low pressures and therefore the infused nitrogen will not immediately rise to the top of the liquid drink in the form of large bubbles and become expelled into the atmosphere. In this manner, the infused nitrogen remains in the liquid drink longer and the creamier, frothier properties of the nitrogen infused liquid drink can be enjoyed for a longer period of time as compared with standard bubble diffusers.

The nitrogen infused liquid drink is then dispensed out of the dispensing tap 126.

The opening of the dispensing tap 126 can be used to initiate the operation of one or more of the compressor 104, the gas generating module 112, the controller 121, the gas infusing module 134 and/or the pump 130. It is further envisaged that sequential operation of some or more of the components can be used to ensure a good quality drink is dispensed. For example, the compressor 104, the gas generating module 112, the controller 121 and/or the gas infusing module 134 may be operated for a period of time before the pump 130 is operated.

The level of infusion of a gas into a liquid will be determined by the length of the hollow fibre tubes 136 used in the gas-infusing membrane module 134. The flowrate of nitrogen is envisaged to be quite low. For example, a flow rate of about 0.1 litres per minute of nitrogen to about 2 litres per minute of coffee might be used, although it will be appreciated that the relative flow rates of gas and liquid may be varied depending on taste, and the selected gas and liquid used.

In order to generate different types of gases, the air intake 102 may be fed with different gaseous compounds, and the permeability of the hollow fibres in the gas generating hollow fibre membrane module 112 can be set so as to cause a separation of molecules as desired when a gaseous compound is passed through the hollow fibres of the gas generating hollow fibre membrane module 112.

In a similar fashion, if a gas different to nitrogen is to be infused into a liquid drink, or into a non-potable liquid in general, then the permeability of the hollow tube fibres 136 in the gas infusing hollow fibre membrane module 134 can be altered so as to ensure a sufficient level of infusion of a particular gas into a specific liquid.

It will be understood that the use and exact locations of the non-return valves 110, 116, 132, filters 106, regulators 108, purity needles 116, cooling coils and/or water separators and other such standard components, which have been described in the foregoing can be varied without departing from the scope of the present invention.

The terms “comprise” and “include”, and any variations thereof required for grammatical reasons, are to be considered as interchangeable and accorded the widest possible interpretation.

It will be understood that the components shown in any of the drawings are not necessarily drawn to scale, and, like parts shown in several drawings are designated the same reference numerals.

It will be further understood that features from any of the embodiments may be combined with alternative described embodiments, even if such a combination is not explicitly recited hereinbefore but would be understood to be technically feasible by the person skilled in the art.

The invention is not limited to the embodiments hereinbefore described which may be varied in both construction and detail within the scope of the appended claims.

1. A liquid drink dispensing apparatus comprising:
a gas generating component and a liquid drink dispensing component; whereby, the gas generating component generates a gas and supplies the generated gas to the liquid drink dispensing component which infuses the generated gas into a liquid drink prior to dispensing the gas-infused liquid drink.

2. (canceled)

3. A liquid drink dispensing apparatus as claimed in claim 1, wherein, the gas generating component comprises a gas generating hollow fibre membrane module which generates the gas by separating the gas from a gaseous mixture; and, the liquid drink dispensing component comprises a gas infusing hollow fibre membrane module to infuse the generated gas into the liquid drink.

4. A liquid drink dispensing apparatus as claimed in claim 2, wherein, the gas generating component comprises a compressor which supplies a compressed gaseous mixture to the gas generating module, and, a buffer tank which stores the generated gas from the gas generating module and supplies the generated gas to the liquid drink dispensing component;
whereby, the gas generating component further comprises a pressure switch connected to the buffer tank such that the pressure switch controls the operation of the compressor based on the pressure level in the buffer tank.

5. A liquid drink dispensing apparatus as claimed in claim 4, wherein, the pressure switch sends a signal to a controller which then processes the signal from the pressure switch and, in turn, may transmit an activation signal to the compressor so as to activate the operation of the compressor.

6. A liquid drink dispensing apparatus as claimed in claim 4, wherein, the operation of the compressor is activated when the pressure level in the buffer tank falls below a preset minimum pressure level.

7. A liquid drink dispensing apparatus as claimed in claim 1, wherein, the gaseous mixture fed into the gas generating module is air and the gas generated by the gas generating module is nitrogen.

8. (canceled)

9. A gas infuser apparatus for infusing a gas into a liquid, wherein, the gas infuser apparatus comprises a gas generating component and a gas infusing component;
whereby, the gas generating component generates a gas and supplies the generated gas to the gas infusing component which infuses the gas into a liquid.

10. (canceled)

11. A gas infuser apparatus as claimed in claim 9, wherein, the gas generating component comprises a gas generating hollow fibre membrane module which generates the gas by separating the gas from a gaseous mixture; and,
the gas infusing component comprises a gas infusing hollow fibre membrane module to infuse the generated gas into the liquid.

12. A gas infuser apparatus as claimed in claim 10, wherein, the gas generating component comprises a compressor which supplies a compressed gaseous mixture to the gas generating module, and, a buffer tank which stores the generated gas from the gas generating module and supplies the generated gas to the gas infusing component; whereby, the gas generating component further comprises a pressure switch connected to the buffer tank such that the pressure switch controls the operation of the compressor based on the pressure level in the buffer tank.

13. A gas infuser apparatus as claimed in claim 12, wherein, the pressure switch sends a signal to a controller which then processes the signal from the pressure switch and, in turn, may transmit an activation signal to the compressor so as to activate the operation of the compressor.

14. A gas infuser apparatus as claimed in claim 12, wherein, the operation of the compressor is activated when the pressure level in the buffer tank falls below a preset minimum pressure level.

15. A gas infuser apparatus as claimed in claim 9, wherein, the gaseous mixture fed into the gas generating module is air and the gas generated by the gas generating module is nitrogen.

16. A process for infusing a liquid drink with a gas, including the steps: delivering a pressurised gaseous mixture into a gas generating module which is used to separate the gaseous mixture into a selected gas and an unwanted gas; delivering the selected gas to a gas infusing module which is used to infuse the generated gas into the liquid drink.

17. The process for infusing a liquid drink with a gas as claimed in claim 16, wherein, the gas generating module comprises a gas generating hollow fibre membrane module; and, the gas infusing module comprises a gas infusing hollow fibre membrane module.

18. The process for infusing a liquid drink with a gas as claimed in claim 17, wherein, the process further comprises extracting one of the selected gas or the unwanted gas through a side wall of the gas generating hollow fibre membrane module, and, discharging the other of the selected gas and the unwanted gas through an outlet of the gas generating hollow fibre membrane module.

19. The process for infusing a liquid drink with a gas as claimed in claim 17, wherein, the process further comprises passing the selected gas through a gas infusing hollow fibre membrane module, whereby the gas infusing hollow fibre membrane module comprises a plurality of hollow fibre tubes housed within a mixing chamber such that the selected gas emanates from one or more of the plurality of hollow fibre tubes and is infused into a liquid drink which has been fed in the mixing chamber.

20. The process for infusing a liquid drink with a gas as claimed in claim 16, wherein, the process includes purifying the selected gas downstream of the gas generating module before delivering the selected gas to the gas infusing module.

21. The process for infusing a liquid drink with a gas as claimed in claim 16, wherein, the process includes delivering the selected gas discharged from the gas generating module to a buffer tank and storing a quantity of the selected gas at a preset pressure in the buffer tank upstream of the gas infusing module and the process includes pressurizing the gaseous mixture upstream of the gas generating module by delivering the gaseous mixture through a compressor, a pressurized gas outlet of the compressor communicating with an inlet of the gas generating module, and the process comprises sensing the as Pressure within the buffer tank and controllin o eration of the compressor in response to said sensed gas pressure for maintaining the selected gas at a desired pressure in the buffer tank, and the process includes filtering the pressurized gaseous mixture in a filter mounted between he compressor and the gas generating module.

22. (canceled)

23. (canceled)

24. (canceled)

25. The process for infusing a liquid drink with a gas as claimed in claim 16, wherein, the process includes regulating the pressure of the gaseous mixture delivered to the gas generating module by means of a pressure regulator mounted upstream of the gas generating module, and the process comprises purifying the selected gas upstream of the gas infusing module, and the process comprises pumping the liquid drink from a liquid drink reservoir into the mixing chamber of the the gas infusing module.

26. (canceled)

27. (canceled)

28. The process for infusing a liquid drink with a gas as claimed in claim 16, wherein the gaseous mixture is air and the selected gas is nitrogen.

29. (canceled)

30. (canceled)

31. (canceled)
